(19) United States
(12) Patent Application Publication
(10) Pub. No.: US 2007/0166835 A1
(43) Pub. Date: Jul. 19, 2007

(54) MULTIPLEX ASSAYS USING MAGNETIC AND NON-MAGNETIC PARTICLES

(75) Inventors: Mark N. Bobrow, Lexington, MA (US); Karl Edwin Adler JR., Newburyport, MA (US); Mack J. Schermer, Belmont, MA (US)

Correspondence Address: FISH & RICHARDSON PC, P.O. BOX 1022, MINNEAPOLIS, MN, 55440-1022, US

(73) Assignee: PERKINELMER LAS, INC., Boston, MA (US)

(21) Appl. No.: 11/615,731

(22) Filed: Dec. 22, 2006

Related U.S. Application Data
(60) Provisional application No. 60/753,493, filed on Dec. 23, 2005.
(60) Provisional application No. 60/753,583, filed on Dec. 23, 2005.

(51) Int. Cl. G01N 1/00

(52) U.S. Cl. 436/174; 209/214

(57) ABSTRACT

Disclosed herein are methods and compositions for multiplexed assays using magnetic and non-magnetic particles. Also disclosed are methods and compositions for performing multi-step assays within a single assay vessel.

### CROSS-REFERENCE TO RELATED APPLICATIONS

This application claims priority to U.S. Application Ser. No. 60/753,493, filed on Dec. 23, 2005, and Ser. No. 60/753,583, filed on Dec. 23, 2005, the contents of which are hereby incorporated by reference.

### SUMMARY

The present invention relates, inter alia, to multiplexed assays (e.g., specific binding assays) using magnetic and non-magnetic particles. The particles can be coded and can have different capture moieties associated with them. In many embodiments the particles are encoded particles. The number of identifiable particle types (the number of bead ID codes) can be increased by mixing magnetic and non-magnetic particles for the assay. Magnetic and non-magnetic particles can share the same codes, but can have different capture moieties associated with them, as the particles can be distinguished based on magnetic properties. For example, the magnetic particles can be separated from the non-magnetic for separate assay detection and/or analysis.

In one aspect, the disclosure features a method for evaluating multiple samples. The method uses a mixture that includes particles, at least some of which are magnetic particles containing capture moiety and others are non-magnetic particles containing capture moiety. The method can include: providing a mixture comprising particles, at least some of which are magnetic particles containing capture moiety and others are non-magnetic particles containing capture moiety; contacting a sample to at least a portion of the mixture; and evaluating at least some of the magnetic particles and the non-magnetic particles that were contacted to the sample.

In some embodiments, the method can also include separating the magnetic particles from the non-magnetic particles prior to the evaluating. In some embodiments, the magnetic particles and non-magnetic particles can be separated using a magnet such as a magnetic probe.

In some embodiments, the magnetic particles can be coded and the mixture can include particles having different codes, wherein each code is associated with a different capture moiety.

In some embodiments, the non-magnetic particles can be coded and the mixture can include particles having different codes, wherein each code is associated with a different capture moiety.

In some embodiments, the magnetic particles and the non-magnetic particles can be coded and the mixture can include particles having different codes, wherein among the magnetic particles each code is associated with a different capture moiety and among the non-magnetic particles each code is associated with a different capture moiety.

In some embodiments, at least some of coded magnetic particles and coded non-magnetic can have the same codes.

In some embodiments, the multiple samples can be evaluated by contacting each to a different portion of the mixture of particles.

In some embodiments, the multiple samples can be contacted to the particles in a well of a multi-well plate such as a 96 or 384 well plate.

In some embodiments, the capture moieties can contain, or be, a polypeptide. In some embodiments, the capture moieties can be, or contain, a nucleic acid such as DNA or RNA.

In another aspect, the disclosure features a multi-step assay method that includes the steps of: providing an assay vessel comprising multiple compartments, the compartments being arranged in sets; (ii) providing particles comprising capture moieties in a first set of the compartments; (iii) removing the particles from the first set of the compartments and disposing them in a second set of the compartments, wherein the second set of the compartments contain a first reagent; (iv) removing the particles from the second set of compartments and disposing them in a third set of compartments, wherein the third set of compartments contain a second reagent. In some embodiments, the method can also include repeating steps (iii) and (iv) for all remaining compartments. In some embodiments, the method can also include detecting at least some of the particle-bound capture moieties disposed in the compartments.

In some embodiments, the sets of compartments can be arranged in a grid with rows and columns.

In some embodiments, at least some of the particles can be magnetic. In some embodiments, at least some of the particles are coded. For example, at least some of the particles can be magnetic and coded. In some embodiments, the magnetic particles are removed using a magnet such as a magnetic probe or other magnetic material.

In some embodiments, the particles can contain a mixture of particles, at least some of which are magnetic particles and others are non-magnetic particles. The magnetic particles can be coded and the mixture can include particles having different codes, wherein each code is associated with a different capture moiety. The non-magnetic particles can be coded and the mixture can include particles having different codes, wherein each code is associated with a different capture moiety. In some embodiments, the magnetic particles and the non-magnetic particles can be coded and the mixture includes particles having different codes, wherein each code is associated with a different capture moiety. Some of coded magnetic particles and coded non-magnetic can have the same codes.

For example, the capture moiety can include a polypeptide or a nucleic acid such as DNA or RNA.

In some embodiments, at least one set of the of the assay vessel can include one or more of: a wash solution, a detection solution, an antibody, or a nucleic acid. The nucleic acid can contain a sequence that is complementary to at least one nucleic acid capture moiety.

In some embodiments, the assay vessel can be a multi-well assay plate such as a 96 or 384 well assay plate.

In another aspect, the disclosure features a multi-compartment assay vessel containing a grid of compartments, wherein a first column of compartments can contain magnetic particles, wherein a second column can contain a first reagent, and at least a third column comprises a third reagent, and wherein the assay vessel can be suitable for transfer of the magnetic particles from the compartments in the first column to compartments in the second, third, and other columns.

In another aspect, the disclosure provides a kit for performing a multi-step reaction. The kit can include: a mixture comprising particles, at least some of which are magnetic particles comprising a capture moiety; and an assay vessel for performing a multi-step reaction. The kit can also include instructions for performing the reaction.

In some embodiments, at least some of the magnetic particles can be coded, wherein each code is associated with a different capture moiety. In some embodiments, the particle mixture can also comprise non-magnetic particles. The non-magnetic particles can be coded and the mixture includes particles having different codes, wherein each code is associated with a different capture moiety. The magnetic particles and the non-magnetic particles can be coded and the mixture includes particles having different codes, among the magnetic particles each code is associated with a different capture moiety and among the non-magnetic particles each code is associated with a different capture moiety. In some embodiments, some of coded magnetic particles and coded non-magnetic can have the same codes.

In some embodiments, at least some of the capture moieties can contain a polypeptide and/or a nucleic acid. The nucleic acid can be RNA or DNA.

In some embodiments, the kit can also contain a wash solution, a detection solution, and/or an antibody for use in the assay. The antibody can be one that specifically recognizes a capture moiety.

In some embodiments, the assay vessel is a multi-well assay plate such as a 96 or 384 well assay plate.

All publications, patent applications, patents, and other references mentioned herein are incorporated by references in their entirety. The materials, methods, and examples disclosed herein are illustrative only and not intended to be limiting.

Other features and advantages of the invention will be apparent from the following description, from the drawings, and from the claims.

### BRIEF DESCRIPTION OF THE DRAWINGS

FIG. 1 is a process flow chart describing the significant steps in one example of the technology.

FIGS. 2A-2E is a sequence of schematic illustrations showing bead separation with a moveable magnetic probe.

FIGS. 3A-3E is a sequence of schematic illustrations showing bead separation with a vessel-wall magnet and a pipette.

FIG. 4 is a schematic drawing of a representative histogram of bead population vs. assay fluorescent signal levels, for a single assay bead set.

FIG. 5 is a plot of carryover of both beads type into their complementary fractions in 10 trials. Separation was performed according to the process outlined in FIG. 3 and the data were collected using a Luminex xMAP instrument.

FIG. 6 depicts the layout of reagents in microplate wells in a pattern according to one aspect of the present invention.

FIGS. 7A-7I are schematic drawings showing a progression of steps of manipulating magnetic assay beads through several assay steps by transferring them from one reagent-filled vessel to another in a pattern according to one aspect of the present invention.

### DETAILED DESCRIPTION

In one aspect of this disclosure, magnetic and non-magnetic particles are used to evaluate a sample. The combination of both particle types can be used, e.g., to extend the capability of encoded bead multiplex assay platforms such as the Luminex platform (Luminex Corporation, Austin Tex.). In particular, the multiplexing limit imposed by a limited number of bead ID codes (or regions) can be exceeded by pooling sets of magnetic and non-magnetic multiplex bead types. Accordingly some or all of the bead ID codes (also termed “regions”) in the non-magnetic set be the same as those used in the magnetic set. Beads that the same codes, but different probes are distinguishable because one species of beads is magnetic (e.g., has some identifiable or magnetically-manipulable characteristic), and the other species is non-magnetic, thereby increasing (as much as doubling) the potential number of analytes (capture moieties) that can be multiplexed.

For multiplex assays, it may be convenient to prepare a pool of particles, e.g., combining different species of particles, each having a unique code. Aliquots of beads from the pooled sets are used to run multiplexed assays against samples. Before analyzing the beads, the magnetic and non-magnetic beads can be separated using known magnetic bead separation technology. The magnetic and non-magnetic bead fractions are then detected (and/or analyzed) separately, allowing their bead ID codes to be overlapping or duplicated.

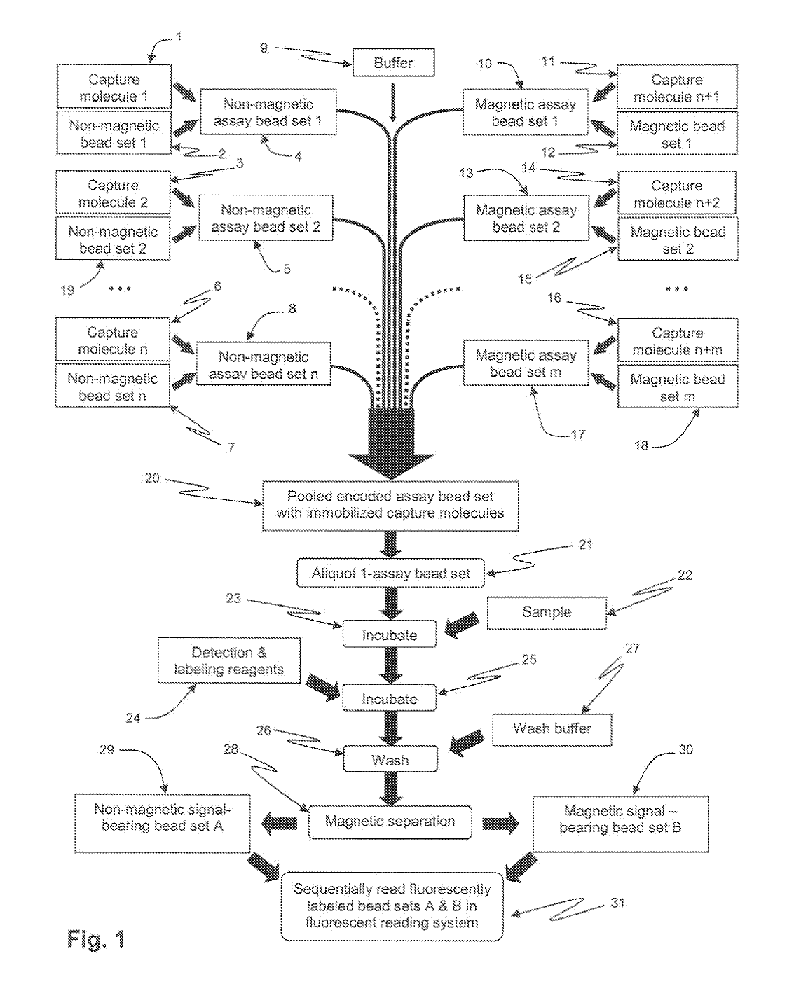

One embodiment of the invention is illustrated in FIG. 1. A first capture moiety is attached to non-magnetic beads having a first code, a second capture moiety to a non-magnetic beads have a second code, and so forth. A third (or next) capture moiety is attached to magnetic beads also having the first code, a fourth capture moiety to magnetic beads having the second code, and so forth. These magnetic and non-magnetic beads can be pooled to provide a particle set.

Beads from the pool can be aliquoted into assay vessels (e.g., wells of a multi-well assay plate such as a 96- or 384-well assay plate). The capture moiety-bound bead sets are subjected to various treatments including incubations and wash steps. Following the reaction steps (one or more incubations and wash steps), is a magnetic separation step, wherein the magnetic bead sets (m) are separated from the non-magnetic bead sets (n). The separated capture-molecule-bound non-magnetic and magnetic bead sets are then read (detected and/or analyzed) using an appropriate detection system (e.g., a fluorescent reading system). Accordingly, the beads having the same code, but different capture moieties can be distinguished. For example, for beads having the first and third capture moiety in the above example, but sharing the first code, the non-magnetic beads with the first code are the ones with the first capture moiety; whereas the magnetic beads with the first code are the ones with the third capture moiety.

As used herein, “capture moiety” and “capture molecule” are used interchangeably, and refer to any analyte (e.g., a molecule) that is attached to a particle as described herein. Thus, the capture moieties are sometimes herein referred to as analytes. Capture moieties can include a diversity of molecules including, e.g., nucleic acids (e.g., DNA, RNA, or modified RNA or DNA), polypeptides (e.g., short polypeptides or macromolecular polypeptide), molecular complexes, or small molecules (e.g., biological small molecules such as steroids, lipids, or saccharides or polysaccharides). Short polypeptides such as those having about 2-100 amino acids, such as, synthetic polypeptides (e.g., chemically synthesized polypeptides), certain growth factors, chemokines, or cytokines, or isolated antibody epitopes. Macromolecular polypeptides, as used herein, refers to polypeptides having more than 100 amino acids such as enzymes (e.g., kinases, hydrolases), antibodies, receptors (intracellular receptors (e.g., estrogen receptors) or cell-surface receptors (e.g., human epidermal growth factor receptors or TNF receptor)), structural proteins (e.g., cytoskeletal proteins), or adhesion molecules (e.g., integrins or adhesions). Macromolecular complexes can be, for example, compositions of one or more polypeptides (e.g., dimeric or trimeric protein complexes). Macromolecular complexes can also be, e.g., entire virus particles. Nucleic acids can be, for example, single or double stranded molecules or can be triplex molecules (i.e., a triple helix molecule containing three strands of DNA complementary to one another). Nucleic acids can be of varying sizes, depending on the application, ranging from small polynucleic acids (e.g., 10, 20, 50, 100, 200, 500, or 1000 base or base-pair nucleic acids) to large polynucleic acids (e.g., 1.5, 2, 5, 8, 10, 15, 20, 50, 100, 150, 200, 250 or more kilobases or kilobase pairs). One class of capture moiety whose utility would be particularly enhanced by an increase in multiplexing capability is Bacterial Artificial Chromosomal (BAC) DNA or other nucleic acids used in comparative genomic hybridization (CGH) (see below). Such probes can be fragmented and then attached to particles according to the methods described herein.

As used herein, a “detection reagent” refers to any agent used to detect the presence or amount of a capture moiety. Generally, a detection reagent is specific for a cognate capture moiety. That is, the detection reagent is one that contains a specific binding activity (an affinity) for a capture moiety. For example, a detection reagent that recognizes the capture moiety can be an antibody, or antigen-binding (capture moiety-binding) fragment thereof. The detection reagent can also be a nucleic acid. For example, when the capture moiety is a nucleic acid, such as a single stranded nucleic acid, the detection reagent can be a like nucleic acid that is complementary to the capture moiety. Such a complementary nucleic acid detection reagent is also sometimes referred to as a “probe” or “nucleic acid probe” (see CGH methods below). A detection reagent can be a single agent, for example, a detectably-labeled antibody or a detectably-labeled nucleic acid molecule, which antibody or nucleic acid specifically recognize and bind to their cognate capture moiety. The detection reagent can also comprise more than one agent such as two members of a specific binding pair. For example, a first non-detectably-labeled agent (e.g., an antibody), which specifically recognizes and binds to the capture moiety, can be linked to a first member of a specific binding pair (e.g., biotin). Subsequently, a second, detectably-labeled agent, linked to a second member of a specific binding pair (e.g., streptavidin), can be contacted to the capture moiety-first agent complex to allow for detection. Examples of suitable assays in which these types of detection reagents can be used in the methods described herein, and suitable detectable tags, are set forth below.

The term “magnetic particle” encompasses any particle having at least some magnetic characteristic, e.g., ferromagnetic, paramagnetic, and superparamagnetic property. The particles can be coded. In some embodiments, the particles can be magnetic and coded. The terms “bead” and “particle” are used interchangeably.

A magnetic particle can include magnetic materials such as iron, nickel, and cobalt, as well as metal oxides such as Fe₃O₄, BaFe₁₂O₁₉, Mn₂O₃, Cr₂O₃, CoO, NiO, and CoMnP. In some embodiments, the magnetic particle contains, or fully consists of, a polymeric magnetic material. Polymeric magnetic material includes for example, material in which the magnetic material is mixed with polymeric material and magnetic material that is coated with polymeric material. Preferably the magnetic material is only one component of the microparticle whose remainder consists of a polymeric material to which the magnetically responsive material is affixed (see coded particles below). Exemplary methods for the preparation of or composition of magnetic particles are described in, e.g., U.S. Pat. Nos. 6,773,812 and 6,280,618.

A magnetic and/or non-magnetic particle useful in a method described herein can have a variety of sizes and physical properties. Particles can be selected to have a variety of properties useful for particular experimental formats. For example, particles can be selected that remain suspended in a solution of desired viscosity or to readily precipitate in a solution of desired viscosity. Particles also can be coded for identification purposes, such as by bar codes, luminescence, fluorescence and the like. A variety of coded particles are well known to those skilled in the art, and include for example, Luminex® and Cyvera® coded particles.

With regard to coded particles, each particle can include a unique code, preferably, the coded particles contain a code other than that present in the detectable tag used to detect the presence or amount of modified substrate (e.g., support-bound product portion, free product portion, or modified support-bound substrate). The code can be embedded (for example, within the interior of the particle) or otherwise attached to the particle in a manner that is stable through hybridization and analysis. The code can be provided by any detectable means, such as by holographic encoding, by a fluorescence property, color, shape, size, light emission, quantum dot emission and the like to identify particle and thus the capture probes immobilized thereto. For example, the particles may be encoded using optical, chemical, physical, or electronic tags. Examples of such coding technologies are optical bar codes fluorescent dyes, or other means.

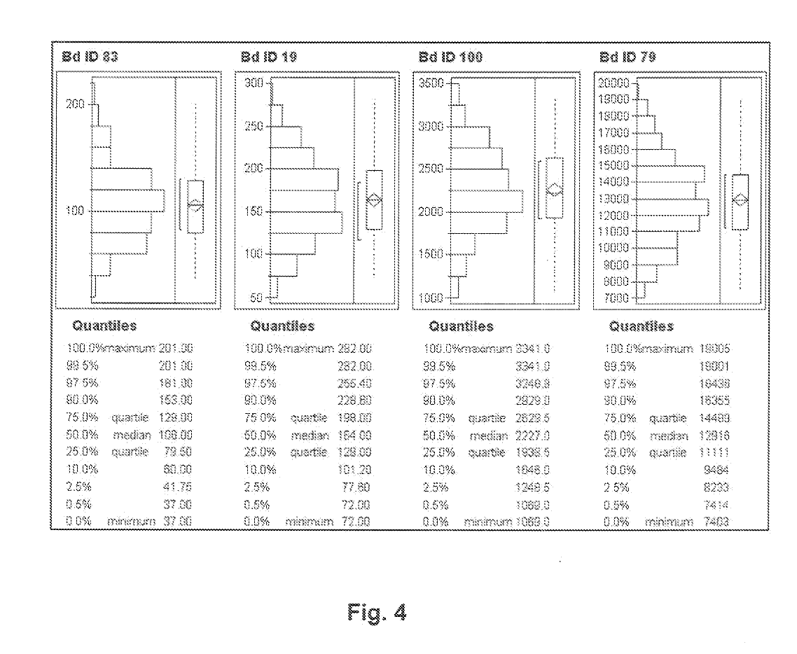

One exemplary platform utilizes mixtures of fluorescent dyes impregnated into polymer particles as the means to identify each member of a particle set to which a specific capture probe has been immobilized. Another exemplary platform uses holographic barcodes to identify cylindrical glass particles. For example, Chandler et al. (U.S. Pat. No. 5,981,180) describes a particle-based system in which different particle types are encoded by mixtures of various proportions of two or more fluorescent dyes impregnated into polymer particles. Soini (U.S. Pat. No. 5,028,545) describes a particle-based multiplexed assay system that employs time-resolved fluorescence for particle identification. Fulwyler (U.S. Pat. No. 4,499,052) describes an exemplary method for using particle distinguished by color and/or size. U.S. Patent Publication Nos. 2004-0179267, 2004-0132205, 2004-0130786, 2004-0130761, 2004-0126875, 2004-0125424, and 2004-0075907 describe exemplary particles encoded by holographic barcodes. FIG. 4 depicts a representative histogram of different fluorescently-encoded particle populations versus their respective assay fluorescent signal levels, for a single assay particle set (or mixture).

U.S. Pat. No. 6,916,661 describes polymeric particles (e.g., microparticles) that are associated with nanoparticles that have dyes that provide a code for the particles. The polymeric microparticles can have a diameter of less than one millimeter, e.g., a size ranging from about 0.1 to about 1,000 micrometers in diameter, e.g., 3-25 μm or about 6-12 μm. The nanoparticles can have, e.g., a diameter from about 1 nanometer (nm) to about 100,000 nm in diameter, e.g., about 10-1,000 nm or 200-500 nm.

As described above, overlapping or identical particle ID codes or regions can be used in both the magnetic and non-magnetic particle sets.

Methods for detecting the particle ID codes, e.g., a fluorescent code, are known in the art and are described below. Examples of systems that read (detect or analyze) multiplex assay signals from either magnetic or non-magnetic Luminex beads include, e.g., the Luminex xMAP 100 and xMAP 200 instruments, respectively.

Another method for detecting and/or separating particle sets based on ID codes is flow cytometry. Methods of and instrumentation for flow cytometry are known in the art, and those that are known can be used in the practice of the present invention. Flow cytometry, in general, involves the passage of a suspension of the particles as a stream past a light beam and electro-optical sensors, in such a manner that only one particle at a time passes through the region. As each particle passes this region, the light beam is perturbed by the presence of the particle, and the resulting scattered and fluorescent light are detected. The optical signals are used by the instrumentation to identify the subgroup to which each particle belongs, along with the presence and amount of label, so that individual assay results are achieved. Descriptions of instrumentation and methods for flow cytometry are known in the art and include, e.g., McHugh, “Flow Microsphere Immunoassay for the Quantitative and Simultaneous Detection of Multiple Soluble Analytes,” Methods in Cell Biology 42, Part B (Academic Press, 1994); McHugh et al., “Microsphere-Based Fluorescence Immunoassays Using Flow Cytometry Instrumentation,” Clinical Flow Cytometry, Bauer, K. D., et al., eds. (Baltimore, Md., USA: Williams and Williams, 1993), pp. 535-544; Lindmo et al, “Immunometric Assay Using Mixtures of Two Particle Types of Different Affinity,” J. Immunol. Meth. 126: 183-189 (1990); McHugh, “Flow Cytometry and the Application of Microsphere-Based Fluorescence Immunoassays,” Immunochemica 5: 116 (1991); Horan et al., “Fluid Phase Particle Fluorescence Analysis: Rheumatoid Factor Specificity Evaluated by Laser Flow Cytophotometry,” Immunoassays in the Clinical Laboratory, 185-189 (Liss 1979); Wilson et al, “A New Microsphere-Based Immunofluorescence Assay Using Flow Cytometry,” J. Immunol. Meth. 107: 225-230 (1988); Fulwyler et al., “Flow Microsphere Immunoassay for the Quantitative and Simultaneous Detection of Multiple Soluble Analytes,” Meth. Cell Biol. 33: 613-629 (1990); Coulter Electronics Inc., United Kingdom Patent No. 1,561,042 (published Feb. 13, 1980); and Steinkamp et al., Review of Scientific Instruments 44(9): 1301-1310 (1973).

Typically, the methods include separating the magnetic coded particles, from the non-magnetic ones.

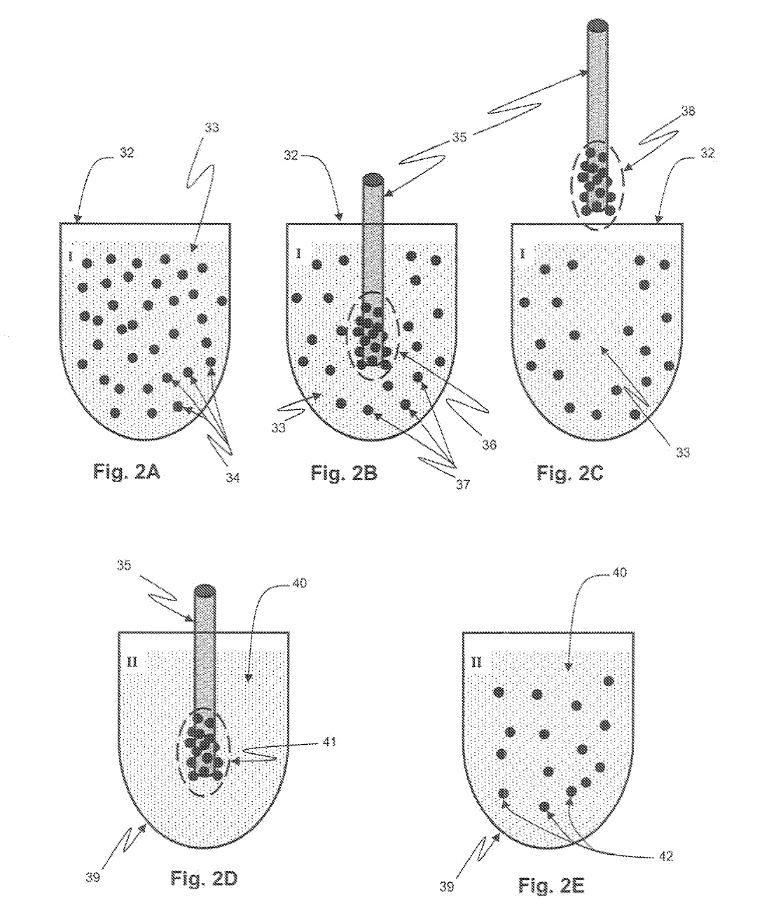

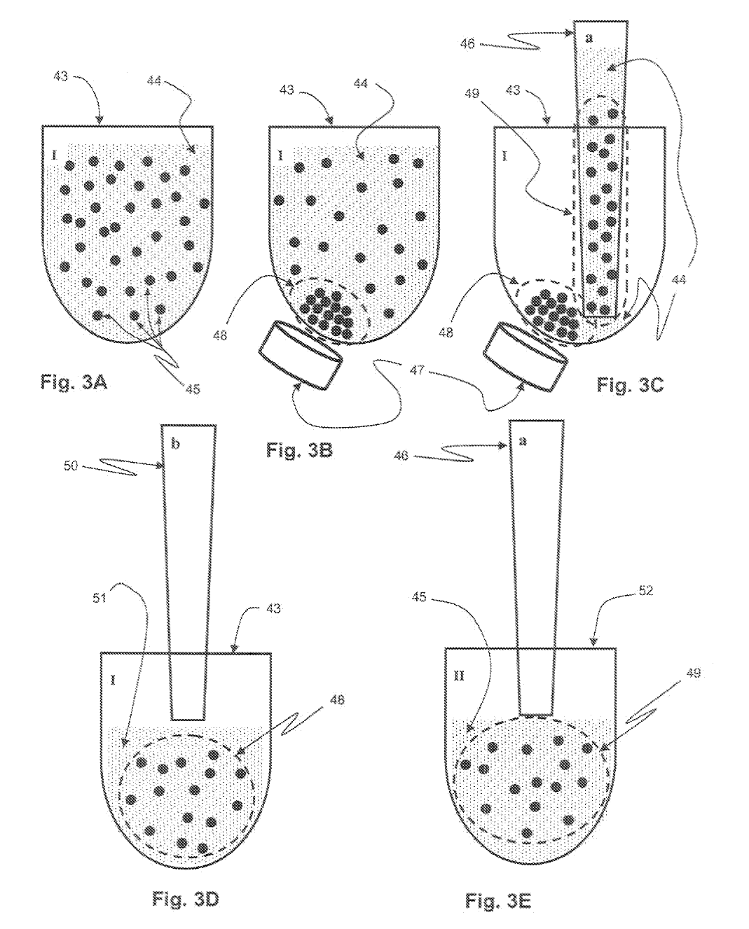

Separation of magnetic particles can involve, e.g., the use of a magnetic probe, which is directly inserted into an assay vessel (e.g., a well of an assay plate) (see FIG. 2) or an external magnet such as a supined, external magnet positioned below the assay vessel (see FIG. 3). Examples of appropriate magnetic probes are the PickPen® 1-M or 8-M magnetic tools (Bio-Nobile Oy, Turku, Finland). These probes allow the magnetic attraction to be effectively turned on and off by moving the location of a permanent magnet from an active position near the tip to an inactive position up inside the tool's housing magnetically shielded from the particles. This is done inside a disposable sheath, allowing a fresh sheath surface to be presented to subsequent samples. Moving the probe around in the vessel to shorten the distance that each magnetic particle needs to travel under magnetic attraction shortens the separation time. Another exemplary device for use in the methods described herein is the MagRo™ 8-M Robotic workstation (Bio Nobile Oy). Both magnetic probes and use thereof are further described in, e.g., U.S. Pat. Nos. 5,647,994; 6,468,810, and 6,280,618. Alternatively, an example of an effective external separation magnet is a samarium-cobalt disk magnet approximately 0.25 inches in diameter by 0.10 inches thick (McMaster-Carr, Dayton N.J.). Ninety-six of these magnets were assembled into a machined polyacetyl holder such that each magnet was located immediately adjacent to a microplate well wall, near the bottom of each well. The Examples provided below also describe use of both types of magnetic devices in the methods described and claimed herein (see also FIGS. 2 and 3).

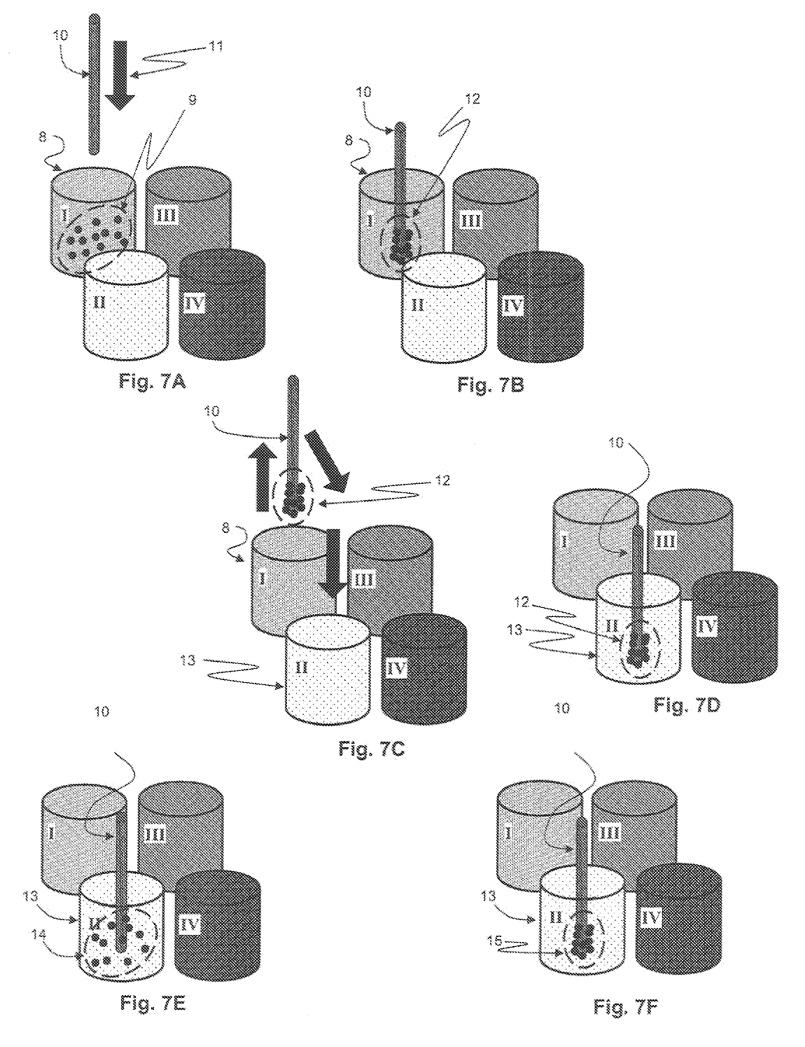

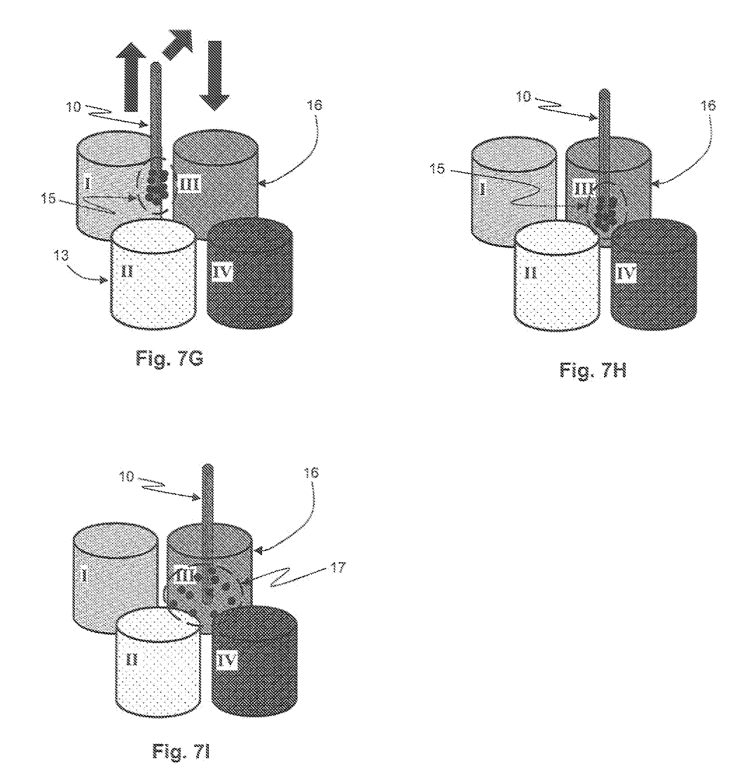

In some embodiments, for example in embodiments where the particles are contacted to more than one sample sequentially, the magnetic particles can be transferred from reagent to reagent using a magnetic probe such as described above. The more than one reagents (e.g., four reagents) can be in separate compartments (wells) of a single assay vessel, an example of which is shown in FIG. 7. The more than one reagents can comprise reagents necessary for a multi-step reaction, such as samples, detection solutions, wash buffers, and the like.

A capture moiety can be covalently or non-covalently bound to a particle. A variety of chemical reactions used to covalently attach a capture moiety to particles (see, for example, Hartmann et al. (2002) J. Mater. Res. 17(2): 473-478). Illustrative examples of functional groups useful for covalent attachment of capture moieties to a particle include alkyl, Si—OH, carboxy, carbonyl, hydroxyl, amide, amine, amino, ammonium, ether, ester, epoxides, cyanate, isocyanate, thiocyanate, sulfhydryl, disulfide, oxide, diazo, iodine, sulfonic or similar groups having chemical or potential chemical reactivity.

Attachment of the capture moiety to the particle can be achieved by electrostatic attraction, specific affinity interaction, hydrophobic interaction, or covalent bonding. Linking groups can be used as a means of increasing the density of reactive groups on the particle and decreasing steric hindrance to increase the range and sensitivity of the assay, or as a means of adding specific types of reactive groups to the particle surface to broaden the range of types of capture moieties that can be affixed to the solid phase. Examples of suitable useful linking groups are polylysine, polyaspartic acid, polyglutamic acid and polyarginine.

Illustrative examples of binding partners useful for non-covalent attachment of capture moieties to a support include antibodies, antibody-like materials, and antibody-binding agents, e.g., but not limited to, staphylococcal protein A or protein G.

The methods described herein can be implemented for a variety of multiplex assay platforms (assays). For example, one type of assay in which the methods described herein can be used is an immunoassay. In this type of assay, a particle-bound capture moiety is exposed to a primary antibody (polyclonal or mAb) that specifically recognizes and binds to the capture moiety. That is, the capture moiety contains an epitope that is specifically recognized by the antibody. Following an incubation of the antibody and particle-bound capture agent for a time sufficient to allow the binding of the antibody to the capture moiety, the unbound antibody is washed away. Where the primary antibody bears a detectable tag, such as a fluorescent, luminescent, or radioactive tag, the binding of the antibody to the capture moiety can be directly detected through detection of the tag. Where the primary antibody is not detectably labeled, a second, detectably labeled antibody that recognizes the primary antibody (e.g., an anti-IgG antibody) can be used to indirectly detect the binding of the primary antibody to the capture moiety. It is understood that other secondary detectably-labeled agents such as antibody-binding staphylococcal protein A and protein G can be used.

Another type of immunoassay that can be used in the methods described herein is a “sandwich” assay. In sandwich assays, an appropriate capture moiety can be immobilized on a particle by, prior to exposing the solid substrate to the test agent, conjugating an antibody specific for the capture moiety (“capture antibody”) to the particle by any of a variety of methods known in the art some of which are described herein. The capture moiety is then bound to the particle (non-covalently) by virtue of its binding to the capture antibody conjugated to the solid substrate. The procedure is carried out in essentially the same manner described above for the immunoassay methods in which the capture moiety is exposed to a primary antibody (detection antibody) that specifically recognizes and binds to the capture moiety, wherein the primary antibody is not the same as the capture antibody. It is understood that in these sandwich assays, the capture antibody can be chosen such that it does not bind to the same epitope (or range of epitopes in the case of a polyclonal antibody) as the detection antibody. Thus, if a mAb is used as a capture antibody, the detection antibody can be either: (a) another mAb that binds to an epitope that is either completely physically separated from or only partially overlaps with the epitope to which the capture mAb binds; or (b) a polyclonal antibody that binds to epitopes other than or in addition to that to which the capture mAb binds. On the other hand, if a polyclonal antibody is used as a capture antibody, the detection antibody can be either (a) a mAb that binds to an epitope that is either completely physically separated from or partially overlaps with any of the epitopes to which the capture polyclonal antibody binds; or (b) a polyclonal antibody that binds to epitopes other than or in addition to that to which the capture polyclonal antibody binds.

In other embodiments, the capture antibody or probe can be bound to a first member of a binding pair and the second member of the binding pair can be detectably-labeled. For example, an antibody or probe can be bound to biotin or streptavidin, and the corresponding biotin or streptavidin is detectably labeled with any of the detectable tags described herein.

Yet another type of assay that can be implemented using the methods described herein is Comparative Genomic Hybridization (CGH), e.g., array CGH. CGH is a molecular cytogenetic method of screening a tumor for genetic changes. The alterations are classified as DNA gains and losses and reveal a characteristic pattern that includes mutations at chromosomal and subchromosomal levels. CGH method is based on the hybridization of fluorescently labeled tumor (frequently Fluorescein-FITC) and normal DNA (frequently Rhodamine or Texas Red) to normal human DNA samples. For example, an array of nucleic acid capture moieties corresponding to segments of normal human chromosomal DNA are bound to magnetic and non-magnetic coded particles as described herein. DNA is isolated from normal and cancer cells and detectably labeled using, e.g., nick-translation. The detectably-labeled (tagged) normal and cancer nucleic acid “probes” are then contacted with relevant capture moieties and allowed to hybridize based on their complementarity to one or more of the capture moieties. Next, the binding of the probes is detected through detection of the detectable tag. Background information on array CGH is available from U.S. Pat. No. 6,562,565 (Pinkel).

The ability to extend the multiplexing capability of an encoded particle platform enables larger, more useful panels of chromosomal loci to be assayed with reduced cost and enhanced efficiencies.

Detectable tags suitable for use in the methods described herein, e.g., detectable tags for use with the detection reagents, are varied and known in the art. Appropriate tags include, without limitation, radionuclides (e.g., ¹²⁵I, ¹³¹I, ³⁵S, ³H, ³²P, or ¹⁴C), fluorescent moieties (e.g., fluorescein, rhodamine, or phycoerythrin), or luminescent moieties (e.g., Qdot™ nanoparticles supplied by the Quantum Dot Corporation, Palo Alto, Calif.). Detectable tags can also be capable of generating a detectable signal, for example, upon addition of an activator, substrate, amplifying agent and the like. In this case, the methods described herein can involve an additional step of exposing the detectably-labeled immunocomplexes (e.g., the capture moiety and the detection antibody or the capture moiety and the probe) with said activators, substrates, or amplifying agents. Well known detectable tags capable of generating a detectable signal include enzyme-labeled antibodies. Exemplary enzymes well known for this purpose include horseradish peroxidase, beta-galactosidase, and beta-glucuronidase. As an example, a detection antibody can be tagged with horseradish peroxidase. Upon formation of a capture moiety-detection antibody (reagent) complex, detection can then be performed using any of a wide range of well known methods for detecting horseradish peroxidase, including 3,3′,5,5′-tetramethylbenzidine (TMB)-based chromogenic methods, 3,3′-diaminobenzidine tetrahydrochloride (DAB)-based chromogenic methods, 3-amino-9-ethylcarbazole (AEC)-based chromogenic methods, Amplex Red dye-based fluorogenic methods, enhanced luminol-based chemiluminescence reactions, electron paramagnetic resonance-based detection of free tyrosyl radical, luminescent semiconductor crystal (quantum dot) and tyramide signal amplification. As such, the capture moiety can, in a resolution or detection step, be contacted with a sample that contains, or is, a detection reagent such as the aforementioned. A capture or detection reagent can be detected by observing a physiochemical property as well as by observing a functional activity of the detectable tag. A physicochemical property such as mass, fluorescence absorption, emission, energy transfer, polarization, anisotropy, and the like, can also be observed, for example.

Methods of detecting and/or for quantifying a detectable tag depend on the nature of the tag and are known in the art. When an intact substrate or detectable tag contains a luminescent or dye component, detection can be by visual observation on a UV transilluminator, or by using a UV-based charged coupled device (CCD) camera detection system, a laser-based gel scanner, a xenon-arc-based CCD camera detection system, a Polaroid camera combined with a UV-transilluminator as well as a variety of other devices used for detecting luminescence. When an intact substrate or detectable tag contains a radioactive component, detection can involve the use of a scintillation or liquid scintillation counter, gamma spectroscopy, Geiger counter, or certain types of X-ray photographic film (e.g., Kodak X-OMAT AR film, Kodak, Rochester, N.Y.). It is understood that the aforementioned methods and devices for detecting detectable tags can be use for the detection and/or identification of particle ID codes.

A sample can contain a detection reagent (e.g., a detection antibody or probe) that specifically recognizes a cognate capture moiety. A sample can have known or uknown content. In some cases, the sample can be derived from an organism (e.g., a subject such as a human patient) or an artificial source. For example, where a capture moiety is a microbial antigen, a sample can be, or contain, an antibody that specifically recognizes the microbial antigen. As a specific example, in a diagnostic test to evaluate which of a set of pathogenic microbial antigens (e.g., antigens from salmonella, human immunodeficiency virus, E. coli. 0517:H7, tuberculosis, rotavirus, hantavirus, ebola virus) elicits an antibody-producing (humoral) immune response in a subject, a number of different antigens from a given microbial pathogen can be bound to magnetic and non-magnetic particles as described above. A sample obtained from a individual infected with the given pathogenic microbe can be contacted to the pooled particle-bound antigens and thus subsequent detection of one or more antibodies binding to their cognate antigens will identify which of the antigens elicit an immune response in the individual.

A biological sample can be, for example, a specimen obtained from an individual or can be derived from such a specimen. For example, a sample can be a tissue section obtained by biopsy, or cells that are placed in or adapted to tissue culture. A sample can also be, or contain, a biological fluid specimen such as urine, blood, plasma, serum, saliva, semen, sputum, cerebral spinal fluid, tears, mucus, sweat, milk, semen, and the like. Biological samples can also be, or contain, fluid from ulcers or other surface eruptions such as blisters and abscesses or can be extracts of tissues from biopsies of normal, malignant, or suspect tissues. In particular, a sample can be obtained from a subject (e.g., a human patient) having, at risk of developing or suspected of having, a cancer. The sample can be a sample from a tissue that is near a tumor or from a tumor. For example, the methods can be used to evaluate the genomic content of cells from a carcinoma or sarcoma or from a tumor of the lung, breast, thyroid, lymphoid, gastrointestinal, genito-urinary tract, an adenocarcinomas, e.g., a malignancy of colon cancer, renal-cell carcinoma, prostate cancer and/or testicular tumors, non-small cell carcinoma of the lung, cancer of the small intestine and cancer of the esophagus. Many chromosomal loci that are altered in cancer are known. See e.g. Dutrillaux et al. Cancer Genet. Cytogenet. 49:203-217 (1990), U.S. Pat. Nos. 5,670,314 (lung carcinomas); 5,635,351 (gliomas); and 6,110,673. The method can be used to evaluate the genomic content of a blood cell, e.g., a B or T cell, or a cell from a leukemia or lymphoma.

A sample can be further fractionated, if desired, to a fraction containing particular components or cell types. For example, a blood sample can be fractionated into serum or into fractions containing particular types of blood cells such as red blood cells or white blood cells (leukocytes). If desired, a sample can be a combination (pool) of samples from an individual such as a combination of a tissue and fluid sample, and the like. A sample can be fractionated or purified to isolate nucleic acids from the sample, for example, RNA or DNA. The samples or fractions thereof can be further processed. For example, the isolated nucleic acids can be detectably labeled, e.g., with a radioactive label (see above).

A sample can also be a man-made sample containing one or more detection agents (e.g., detectably labeled antibodies or probes). In some embodiments, a sample can be, or contain, a wash solution. In some embodiments, the sample can be, or contain, a detection solution (see above). In some embodiments of the methods, the particle sets can be contacted with more than one sample.

A sample can be processed to eliminate or minimize the presence of interfering substances (interfering antibody components or unwanted enzymatic activities which may degrade or adversely affect the capture moiety or the binding of, e.g., a probe or detection antibody), as appropriate. If desired, a sample can be fractionated by a variety of methods well known to those skilled in the art, including subcellular fractionation, and chromatographic techniques such as ion exchange, hydrophobic and reverse phase, size exclusion, affinity, hydrophobic charge-induction chromatography, and the like (Ausubel et al. supra, 1999; Scopes, Protein Purification: Principles and Practice, third edition, Springer-Verlag, New York (1993); Burton and Harding, J. Chromatoqr. A 814:71-81 (1998)).

Samples can also be from non-human sources. As such, samples can be obtained, for example, from any veterinary or research subject where the methods described herein could be useful. Examples of such non-human animals include, but are not limited to, a horse, dog, cat, rabbit, rat, mouse, fish, turtle, bird, and lizard.

Samples can also be obtained from lower organisms, such as yeast, archebacteria and bacteria, and plants.

For use in a method described herein, a sample can be in a variety of physical states. For example, a sample can be a liquid or solid, can be dissolved or suspended in a liquid, can be in an emulsion or gel, and can be absorbed onto a material.

Non-limiting examples of sample receptacles include sample wells, tubes, capillaries, vials and any other vessel, groove or indentation capable of holding a sample, including those containing membranes, filters, matrices and the like. A sample receptacle also can be contained on a multi-sample platform, such as a microplate, slide, microfluidics device, array substrate, mass spectrometry sample plate, and the like.

Also featured are methods of performing a multi-step assay within a single assay vessel using magnetic particles. The methods use a manipulator to transfer particles from one set of compartments to another. The transfers can be performed serially and can be combined with other steps, e.g., washing, agitation, binding reactions, and so forth. By transferring particles, the need to manipulate liquids is reduced.

For example, a plurality of reagents required to perform an assay are placed in adjacent wells of a multi-well plate. A manipulator, such as a magnetic probe described above, can then be used to transfer a set of particles (e.g., paramagnetic particles) from one well to another, generally with particle transfer to and from at least 4 wells being required to perform a complete assay. The magnetic particles, for example, can comprise a capture moiety as described above. For example, the particles are contacted with a first well to indirectly label a capture moiety, the a second well for a first wash step, then to a third well containing a fluorescent reporter, and finally to a fourth well as a second wash step.

This approach also allows all of the components of a multi-step assay to be provided within the wells of a microplate. For example, kits can be produced with different sets of solutions in different respective columns of a microplate. Users of such kits can transfer particles from one column to another. In certain embodiments, the first column can include the magnetic particles (either a homogenous set, or a set of encoded magnetic particles wherein different capture moieties are associated with a code). When the kit is used, different samples can be placed into the first compartment of each row, i.e., in the compartments containing the magnetic particles. After binding or other reaction, the particles can be transferred to the second column, e.g., containing a washing reagent. In some embodiments, one of the columns includes a detection reagent (a detection reagent comprising a detectable tag), or a mixture of different detection reagents or other reagents for performing and/or monitoring enzyme reactions (e.g., those useful for detection; see above). After further washing particles can be evaluated, e.g., by using a flow cytometers to evaluate multiple different detectable tags or detectable enzymatic activities.

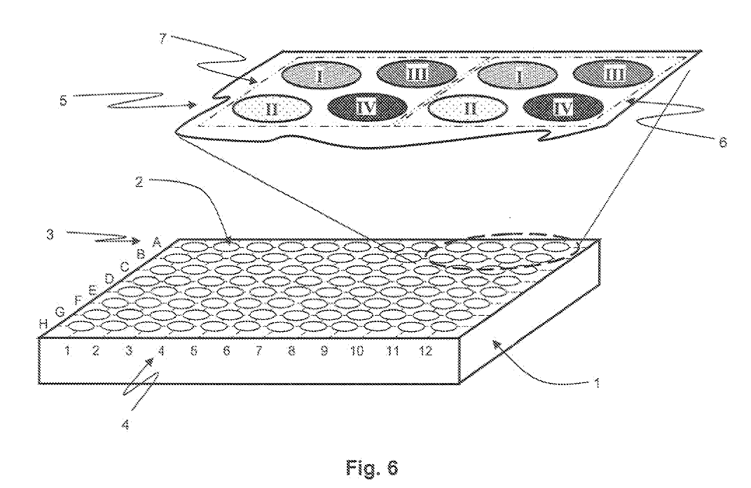

As a further illustration, FIG. 6 depicts an exemplary assay microplate. As used herein a “microplate” is a multi-well assay vessel made according to standards set by the Society of Biomolecular Screening, which typically has 96 or 384 wells (96 wells as shown in FIG. 6). The wells of the microplate are laid out in rows and columns, wherein the rows are designated with letters and the columns with numbers (see FIG. 6, numerical indicators 3 and 4 respectively). The figure includes a magnified view of its wells divided into subsets, wherein the wells of each subset contain a collection pre-loaded reagents loaded into the wells according to a pattern (see numerical indicator 6). Two of the subsets (numerical indicators 6 and 7) are shown in the magnified view; which subsets each contain four wells, and each well in the subset is numbered in the figure with Roman numeral I through IV. According to one embodiment of the present invention, each subset of wells would contain all of the reagents required to run a multi-step non-homogeneous assay.

FIG. 7A-7I depict an exemplary set of particle transfer steps according to one aspect of the present invention. First, a sample is incubated with a magnetic particle set comprising capture moiety in the I well (FIG. 7A). For example, the magnetic particle set can contain paramagnetic polymer particles for use in the Luminex xMAP multiplex assay system. A magnetic particle manipulator probe is then inserted into the I well (as shown in FIG. 7B). Next, the magnetic probe is activated, drawing the particle set into contact with the probe for subsequent transport (see FIG. 7C, numerical indicators 10 and 12). Motion of the probe in the plane of the microplate to sweep it through much of the volume of the well speeds up the collection of the particles by briefly bringing the probe very close to each particle, dramatically increasing the magnetic attraction. The probe carrying the particle set is then raised out of the I well, translated to a position above the II well (see FIG. 7C), and then lowered into the II well (see FIG. 7D). Next, the probe is deactivated and the particles are released from the probe, allowing them to disperse in the liquid medium of the II well (see FIG. 7E). This dispersion and suspension of the particles allows the capture moieties immobilized upon the particle surfaces to react with the assay media with kinetics approaching those of the given solutions. Following this reaction step, the magnet of probe is re-actuated and used to collect the particles at the probe's surface.

The particles are then transferred from the II well to the III well (as described above), where they are again dispersed and suspended. This operation can continue through all of the wells in each subset until the reaction is completed.

An example of an assay that can be performed using the multi-step assay methods described above is a sandwich immunoassay (also see above). For example, in an immunoassay with 4 steps in corresponding wells I-IV, the I well would contain a capture antibody (a first detection reagent) in buffer. Well II would contain a enzyme-labeled (detectably labeled) secondary antibody (a second detection reagent). Well III would contain a suitable detection solution, and well IV would contain a wash buffer from which assay particles could be, optionally removed and, analyzed. In this example, the 96-well microplate would have the capacity for 24 4-step sandwich assays.

The magnetic particles, capture moieties, exemplary assays, magnetic probes, and detection reagents can be any of those described herein.

It is understood that modifications that do not substantially affect the activity of the various embodiments of this invention are also included within the definition of the invention provided herein. Accordingly, the following examples are intended to illustrate but not limit the present invention.

### EXAMPLES

### Example 1

### Creating and Running a Multiplex Assay Using Magnetic and Non-Magnetic Particles

Preparation or manufacture of a multiplex assay bead set (Numbers in parentheses are the numerical identifiers depicted in FIG. 1). To create and perform a multiplex assay using magnetic and non-magnetic particles, first, specific capture moieties (capture molecules) (e.g., nucleic acids or antibodies) for each desired analyte are immobilized on sets of one bead type, i.e., sets of beads that have a single encoded bead ID or region. In the example shown in FIG. 1, a first capture moiety (1) is immobilized onto a first non-magnetic bead set (2) to form a first non-magnetic assay bead set (4). Similarly, other capture moieties (3, 6) are immobilized on other non-magnetic bead sets (19, 7) to form a collection of “n” non-magnetic assay bead sets (5, 8), wherein n is an integer greater than or equal to 1. In addition, yet other capture moieties (11, 14, and 16) are immobilized on magnetic bead sets (12, 15, and 18) respectively to form a second collection of m magnetic assay bead sets. As described above, overlapping or identical bead ID codes or regions can be used in both the magnetic and non-magnetic bead sets.

The assay beads sets, both non-magnetic and magnetic, are then pooled together to form a pooled encoded assay bead set with immobilized capture moieties (20).

Use of aliquots of this bead set in multiplexed assays (Numbers in parentheses are the numerical identifiers depicted in FIG. 1). To perform an assay (multiplexed assay) with steps consistent with a sandwich immunoassay (also see above), first, a fraction or aliquot (21) of the encoded bead set (20) is incubated (23) with a sample (22) such as a complex biologically-derived mixture containing or suspected of containing some or all of the analytes to which the capture moieties are specifically targeted. Using Luminex xMAP™ beads, for example, each assay aliquot should contain between about 500 and 10,000 members of each assay bead set, preferably between 500 and 2,000. Then, detection and labeling reagents (24) are added and a second incubation (25) is performed. A wash step (26) is then performed by the addition of a wash buffer 27 to eliminate unbound and non-specifically bound labeling reagents. This wash step is performed, for example, in a well of a filter plate (a standard microplate with filter media in the bottom of each well), using vacuum to draw out the liquid reagents while leaving the beads in the well. The final stage of washing resuspends the beads in additional added wash buffer (26).

The washed bead set is then separated (28) into a non-magnetic signal-bearing bead set A (29) and a magnetic signal-bearing bead set B (30). The separation of magnetic beads from non-magnetic beads can be performed in a variety of ways, two of which are described below. The separated signal-bearing bead sets (29 and 30) are then read separately (31), typically sequentially, by a multiplex bead reading system such as the Luminex xMAP 100™ and xMAP 200™ instruments, which read multiplex assay signals from either magnetic or non-magnetic Luminex® beads interchangeably. In this manner, up to 200 analytes can be analyzed using the Luminex system, which in its current implementations can accommodate a maximum of 100 bead ID codes or regions, limiting it to 100-plex or lower multiplex assays.

Separating magnetic beads from non-magnetic beads using a magnetic probe (Numbers in parentheses are the numerical identifiers depicted in FIG. 2A-2E). To separate the magnetic beads from the non-magnetic beads, a first assay vessel (32) such as a filter plate well contains buffer (33), in which a mixture of magnetic and non-magnetic signal-bearing multiplex assay beads (34) are suspended. An activated magnetic probe (35) is inserted into the vessel (32). After a period of time where the probe is immersed in the buffer (33), the magnetic beads (36) migrate to and become magnetically captured by the activated probe, while the non-magnetic beads (37) are unaffected and remain in suspension in the buffer.

After adhering to the magnetic beads, the probe (35) is withdrawn from the vessel (32) with a set of captured magnetic beads (38) on its surface. Subsequently, the probe (35) is inserted into a second assay vessel (e.g., another microplate well) filled with a second buffer (40). The buffer is typically the same wash buffer used in previous steps. The probe is then de-activated to release the captured magnetic beads (42) and allowing them to be suspended in the buffer (40). The non-magnetic signal-bearing beads can be read from the initial vessel (depicted in FIG. 2C) and the magnetic beads from the second vessel (as depicted in FIG. 2E).

Separating magnetic beads from non-magnetic beads using an external supined magnet (Numbers in parentheses are the numerical identifiers depicted in FIG. 3A-3E). Alternatively, magnetic beads can be separated from non-magnetic beads using an external supined magnet. A first assay vessel (43) such as a filter plate well contains buffer (44) in which a mixture of magnetic and non-magnetic signal-bearing multiplex assay beads (45) are suspended. An external separation magnet (47) is brought into close proximity to, or direct contact with, the wall of the vessel (43). Following application of the magnet, a plurality of the magnetic beads migrate to the vessel wall adjacent to the magnet and form a pellet (48) while the non-magnetic beads remain in suspension.

To separate the non-magnetic beads from the magnetic bead pellet, a first pipette (46) is inserted into the first well (43). The first pipette aspirates the buffer (44) and the suspended non-magnetic beads (49) while the magnetic beads remain bound in a pellet (48) on the well wall. A small amount of buffer and a small number of non-magnetic beads is left behind, and the extent and significance of this carryover is described below (see Example 2).

Once the non-magnetic particles have been removed from the well (as in FIG. 3C), the separation magnet is removed from the outside of the first vessel (43), releasing the magnetic force holding the magnetic beads to the vessel wall. Subsequently, a second pipette (50) dispenses buffer (51), typically the wash buffer used in a previous wash step, to resuspend the magnetic beads (48). The first pipette (46) that had aspirated the non-magnetic beads dispenses them in their buffer into a second assay vessel (52). The non-magnetic signal-bearing beads are analyzed from the second vessel (as shown in FIG. 3E) and the magnetic beads are analyzed from the first vessel (as shown in FIG. 3D).

### Example 2

### Measurement of Bead Carryyover from Trial Multiplex Bead Separation

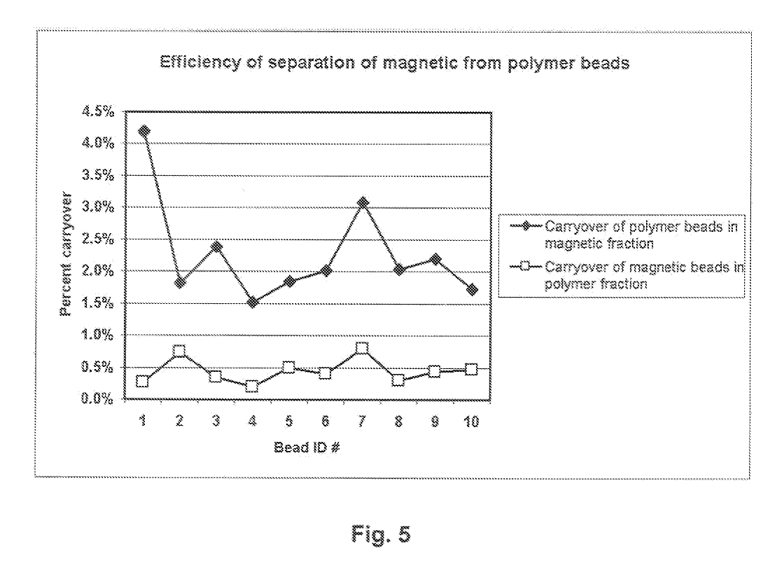

Ten sets of magnetic beads and ten sets of non-magnetic beads, each with a different bead ID, were combined into a multiplex mixture with a total of 20 bead types all with different bead IDs. Approximately 2,000 beads of each ID were mixed into 20 μl of buffer. Separation was performed as shown in FIG. 3 (magnet beneath the assay well) and the separated fractions were detected using a Luminex xMAP 200™ instrument (Luminex Corporation, Austin, Tex.). The fractions of carryover bead IDs in each fraction for each of the 10 IDs are shown in FIG. 5 as carryover percentages. That is, the percentage of carryover for each of the non-magnetic 10 IDs in the magnetic fraction (black diamonds) and the carryover for each of the magnetic 10 IDs in the non-magnetic fraction (open squares) are shown. The number of magnetic beads carried over into the nominally non-magnetic fraction was consistently below 1%, and the magnetic beads carried over into the nominally non-magnetic fraction was less than about 4%. This level of carryover will not materially affect multiplex assay results when the trimmed-mean or median bead signal is used as the output.

Other embodiments are within the following claims:

What is claimed is:

1. A method for evaluating multiple samples, the method comprising:
providing a mixture comprising particles, at least some of which are magnetic particles comprising capture moiety and others are non-magnetic particles comprising capture moiety;
contacting a sample to at least a portion of the mixture; and
evaluating at least some of the magnetic particles and the non-magnetic particles that were contacted to the sample.

2. The method of claim 1, further comprising separating the magnetic particles from the non-magnetic particles prior to the evaluating.

3. The method of claim 2, wherein the magnetic particles and non-magnetic particles are separated using a magnet.

4. The method of claim 1, wherein the magnetic particles are coded and the mixture includes particles having different codes, wherein each code is associated with a different capture moiety.

5. The method of claim 1, wherein the non-magnetic particles are coded and the mixture includes particles having different codes, wherein each code is associated with a different capture moiety.

6. The method of claim 1, wherein the magnetic particles and the non-magnetic particles are coded and the mixture includes particles having different codes, wherein among the magnetic particles each code is associated with a different capture moiety and among the non-magnetic particles each code is associated with a different capture moiety.

7. The method of claim 6, wherein at least some of coded magnetic particles and coded non-magnetic have the same codes.

8. The method of claim 1, wherein multiple samples are evaluated by contacting each to a different portion of the mixture of particles.

9. The method of claim 8, wherein the multiple samples are contacted to the particles in a well of a multi-well plate.

10. The method of claim 1, wherein at least some of the capture moieties comprise nucleic acid.

11. The method of claim 1, wherein at least some of the capture moieties comprise a polypeptide.

12. A reaction mixture comprising a mixture comprising particles, at least some of which are magnetic particles comprising capture moiety and others are non-magnetic particles comprising capture moiety.

13. A multi-step assay method comprising:
(i) providing an assay vessel comprising multiple compartments, the compartments being arranged in sets;
(ii) providing particles comprising capture moieties in a first set of the compartments;
(iii) removing the particles from the first set of the compartments and disposing them in a second set of the compartments, wherein the second set of the compartments contain a first reagent;
(iv) removing the particles from the second set of compartments and disposing them in a third set of compartments, wherein the third set of compartments contain a second reagent.

14. The method of claim 13, further comprising repeating steps (iii) and (iv) for all remaining compartments.

15. The method of claim 13, further comprising detecting at least some of the particle-bound capture moieties disposed in the compartments.

16. The method of claim 13, wherein the sets of compartments are arranged in a grid with rows and columns.

17. The method of claim 13, wherein at least some of the particles are magnetic.

18. The method of claim 13, wherein at least some of the particles are coded.

19. The method of claim 13, wherein at least some of the particles are magnetic and coded.

20. The method of claim 13, wherein the particles comprise a mixture of particles, at least some of which are magnetic particles and others are non-magnetic particles.

21. The method of claim 20, wherein the magnetic particles are coded and the mixture includes particles having different codes, wherein each code is associated with a different capture moiety.

22. The method of claim 20, wherein the non-magnetic particles are coded and the mixture includes particles having different codes, wherein each code is associated with a different capture moiety.

23. The method of claim 20, wherein the magnetic particles and the non-magnetic particles are coded and the mixture includes particles having different codes, wherein each code is associated with a different capture moiety.

24. The method of claim 23, wherein some of coded magnetic particles and coded non-magnetic have the same codes.

25. The method of claim 13, wherein at least some of the capture moieties comprise nucleic acid.

26. The method of claim 13, wherein at least some of the capture moieties comprise a polypeptide.

27. The method of claim 13, wherein at least one set of the of the assay vessel contains an antibody.

28. The method of claim 25, wherein at least one set of the of the assay vessel contains a nucleic acid.

29. The method of claim 28, wherein the nucleic acid comprises a sequence that is complementary to at least one nucleic acid capture moiety.

30. The method of claim 13, wherein the assay vessel is a multi-well assay plate.

31. The method of claim 17, wherein the magnetic particles are removed using a magnet.

32. The method of claim 31, wherein the magnet is a magnetic probe.

33. A multi-compartment assay vessel comprising a grid of compartments, wherein a first column of compartments comprises magnetic particles, wherein a second column comprises a first reagent, and at least a third column comprises a third reagent, and wherein the assay vessel is suitable for transfer of the magnetic particles from the compartments in the first column to compartments in the second, third, and other columns.

34. A kit for performing a multi-step reaction, the kit comprising:
a mixture comprising particles, at least some of which are magnetic particles comprising a capture moiety; and
an assay vessel for performing a multi-step reaction.
